(19) United States
(12) Patent Application Publication
(10) Pub. No.: US 2026/0187695 A1
(43) Pub. Date: Jul. 2, 2026

(54) IDENTIFYING CONSTRAINT-CONSISTENT REPLACEMENTS FOR ITEMS USING A GENERATIVE LANGUAGE MODEL

(71) Applicant: Maplebear Inc., San Francisco, CA (US)

(72) Inventor: Riddhima Sejpal, Dublin, CA (US)

(21) Appl. No.: 19/007,409

(22) Filed: Dec. 31, 2024

(51) Int. Cl. G06Q 30/0601

(52) U.S. Cl. CPC G06Q 30/0631; G06Q 30/0639

(57) ABSTRACT

An online system receives a request from a client device associated with a user to place an order and retrieves user data including a constraint associated with the user. Upon receiving a notification that an item included in the order is not available at a source location, the system generates a prompt including item data for the item, a description of the constraint, contextual information associated with the order, and a request to identify a replacement for the item based on information describing a set of candidate replacement items available at the source location, the item data, the constraint, and the contextual information. The system provides the prompt to a large language model to obtain an output and extracts information describing the replacement from the output. The system generates a message including a suggestion to replace the item with the replacement and sends the message to the client device.

### BACKGROUND

Online systems may allow their users to place orders that are serviced on their behalf by pickers (e.g., by driving to source locations, collecting items included in the orders, and delivering the orders to the users who placed the orders). When items are not available at the time of fulfillment, pickers generally identify similar items and communicate information describing them to users for their approval. For example, if a picker is unable to find a particular brand of whole wheat bread included in an order, they may identify a different brand of whole wheat bread as a replacement and communicate information describing the replacement to a user who placed the order for their approval. In this example, if the user approves of the replacement, the picker may then collect it and proceed with collecting any remaining items in the order.

However, pickers may have difficulty identifying suitable replacements for items. In the above example, if the user declines the replacement due to their preferences, dietary restrictions, budget, or based on an ineligibility of the replacement to be acquired using benefits the user receives from another source, the picker may suggest additional replacements until the user approves of a replacement. Continuing with this example, identifying a suitable replacement may be time-consuming and inefficient, especially if the user needs to determine whether each suggested replacement is consistent with their preferences, dietary restrictions, budget, is eligible to be acquired using the benefits, if the user is unable to promptly approve or decline a suggested replacement, etc. In this example, the amount of time that may be required to identify a suitable replacement may result in delayed delivery of the order and any other orders the picker is servicing. Moreover, in this example, further delays may result if other items included in the order also are not available.

### SUMMARY

In accordance with one or more aspects of the disclosure, an online system identifies constraint-consistent replacements for items using a large language model. More specifically, an online system receives a request from a first client device associated with a user of the online system to place an order including one or more items and retrieves a set of user data for the user, in which the set of user data includes a set of constraints associated with the user and the set of constraints includes a budget associated with the items. The online system then receives, from a second client device associated with a picker servicing the order, a notification that an item included in the order is not available at a source location. The online system generates a prompt including a set of item data for the item, a description of the set of constraints, a set of contextual information associated with the order, and a request to identify a set of replacements for the item based on information describing a set of candidate replacement items available at the source location, the set of item data for the item, the set of constraints, and the set of contextual information associated with the order. The online system provides the prompt to a large language model to obtain an output and extracts information describing the set of replacements for the item from the output. The online system then generates a message including a suggestion to replace the item with a replacement included among the set of replacements for the item and sends the message to the first client device associated with the user, causing the first client device to display the message in a messaging interface associated with the user and the picker. In one or more embodiments, the prompt also includes an additional request to generate an explanation describing a suitability of the set of replacements for the item based on the set of constraints. In such embodiments, the online system may extract the explanation from the output and include the explanation in the message.

Thus, the online system may identify the set of replacements for the item based on the set of constraints (e.g., a budget, a payment or dietary restriction, etc.) specific to the user. By doing so, the likelihood that the user will find a replacement identified by the online system suitable is increased, even if the picker proceeds with collecting the replacement without receiving approval from the user in a timely manner. Additionally, by including the explanation describing the suitability of the set of replacements for the item, the online system may directly address any concerns the user may have about each replacement, eliminating the need for the user to verify whether it is consistent with the set of constraints.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for identifying a set of constraint-consistent replacements for an item using a large language model, in accordance with one or more embodiments.

FIG. 4 illustrates an example of a messaging interface associated with a user and a picker, in accordance with one or more embodiments.

### DETAILED DESCRIPTION

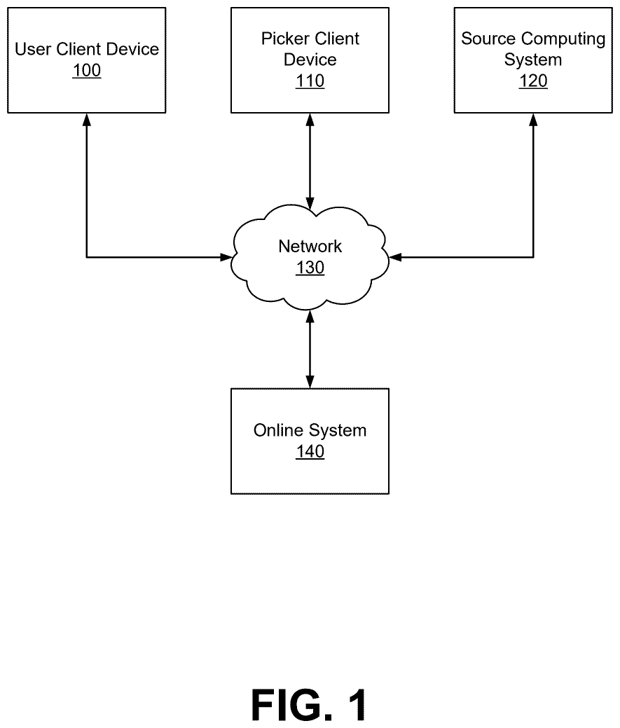

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more source locations from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user's order to the picker in a collection interface. The collection interface is a user interface that provides information to the picker identifying items to collect for a user's order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be a user client device 100 being operated by a user collecting items for themselves within the source location. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

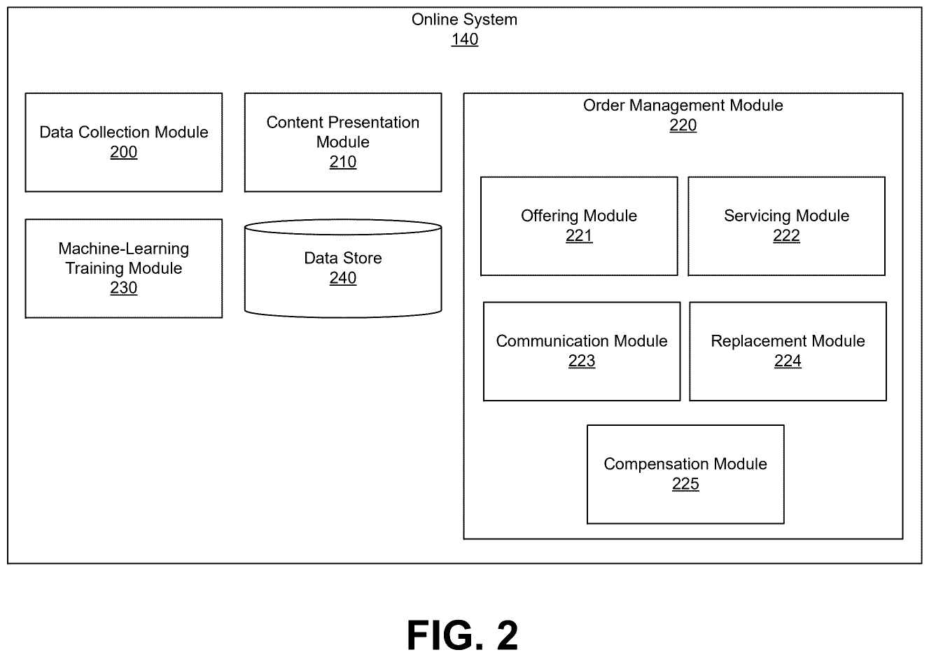

As an example, the online system 140 may allow a user to order groceries from a grocery store source. The user's order may specify which groceries they want to be delivered from the grocery store source and the quantities of each of the groceries. The user's client device 100 transmits the user's order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address, preferences, (e.g., shopping or dietary preferences, preferred payment instruments, favorite items, sources, source locations, recipes, or cuisines, etc.), restrictions (e.g., dietary or payment restrictions) or stored payment instruments. User data also may include demographic information associated with a user (e.g., age, gender, geographical region, etc.) or household information associated with the user (e.g., a number of people in the user's household, whether the user's household includes children or pets, etc.). Furthermore, user data may include information describing a budget associated with a user. A budget may describe a maximum amount (e.g., a dollar amount or a benefits amount) a user may spend on an order or an item (e.g., an item associated with an item category). Additionally, a budget may be specified by a user or derived by the data collection module 200 based on historical order data associated with the user or a program (e.g., a food assistance program) associated with the user, as described below. The user data also may include various types of information describing benefits (e.g., credits, program benefits, cash, etc.) provided to a user that the user may use to acquire certain items from a source location. Examples of such types of information include: information identifying a program (e.g., a food assistance program) that provided the benefits, information describing items that may be acquired using the benefits, information describing a set of unused benefits the user has remaining, an expiration of the set of unused benefits, or any other suitable types of information. The user data also may include default settings established by the user, such as a default source/source location, payment instrument, delivery location, or delivery timeframe. The data collection module 200 may collect the user data from sensors on the user client device 100 or based on the user's interactions with the online system 140.

The user data also may include information describing one or more constraints associated with a user. The constraints may include a budget associated with the user, a set of payment restrictions associated with the user, a set of dietary restrictions associated with the user, or any other suitable types of constraints. For example, the user data may include information describing a payment restriction associated with a user, such as information describing items that may be acquired using benefits provided to the user by a food assistance program and a maximum amount of benefits the user may spend on an order (i.e., a number of unused benefits the user has remaining). As an additional example, the user data may include information describing a set of dietary restrictions associated with a user, such as information indicating that the user is allergic to nuts and is vegetarian. The constraints may be described by or derived from other data stored in the data store 240 (e.g., information describing the user's preferences, benefits provided to the user by a program, order data associated with the user, or any other suitable types of information). For example, a payment restriction associated with a user may be described by historical order data associated with the user indicating that at least a threshold percentage of items ordered by the user were acquired using benefits provided by an assistance program.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), serial number, price, item category, brand, quality (e.g., freshness, ripeness, etc.), ingredients/materials, manufacturing location, version/variety (e.g., flavor, low fat, gluten-free, organic, vegetarian, etc.) of an item. Item data also may indicate whether an item is eligible to be acquired using benefits provided by a program. For example, item data may describe a number of credits provided by a food assistance program required to acquire an item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item. The data collection module 200 may collect item data from a source computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as apples, oranges, lettuce, and cucumbers may be included in a “produce” item category. As an additional example, items such as garlic bread, pasta, and alfredo sauce may be included in an “Italian cuisine” item category, while items such as soy sauce and kimchi may be included in an “Asian foods” item category. As yet another example, cereal may be included in a “breakfast” item category, while frozen lasagna and pizza may be included in a “lunch” and a “dinner” item category. As another example, macaroni salad may be included in a “side dish” item category, while pie may be included in a “dessert” item category. Furthermore, in various embodiments, an item may be included in multiple categories. For example, croissants may be included in a “croissant” item category, a “pastry” item category, and a “bakery” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the source locations from which the picker has collected items, or the picker's previous shopping history. Additionally, the picker data may include preferences expressed by the picker, such as their preferred source locations for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data include user data for users associated with the order, such as user data for a user who placed the order or picker data for a picker who serviced the order. Order data also may include a set of contextual information associated with the order. Examples of contextual information associated with an order include: a set of item data for each item included in the order, a set of instructions associated with the order, one or more messages associated with the order included in a messaging interface associated with a user who placed the order and a picker servicing the order, or any other suitable types of information. For example, contextual information associated with an order may include a price of each item included in the order, a set of instructions provided by a user who placed the order to collect only organic produce, and messages associated with the order included in a messaging interface associated with the user and a picker servicing the order indicating that fresh organic tomatoes are not available and that the user is willing to replace the fresh organic tomatoes with canned organic tomatoes.

The data collection module 200 also may derive various types of information based on other data stored in the data store 240 and store the derived information in the data store 240 (e.g., in association with the data from which it was derived). For example, based on historical order data associated with a user, the data collection module 200 may derive a budget associated with the user corresponding to a highest amount (e.g., a dollar amount or a benefits amount) the user spent on an order within the last month. In the above example, based on the historical order data associated with the user, the data collection module 200 also or alternatively may derive one or more additional budgets associated with the user, in which each additional budget corresponds to a highest amount (e.g., a dollar amount or a benefits amount) the user spent on items associated with an item category within the last month. As yet another example, the data collection module 200 may retrieve information describing payment instruments (e.g., credit cards, benefits provided by an assistance program, bank accounts, etc.) associated with a user from historical order data associated with the user and derive a preferred payment instrument associated with the user based on a frequency with which the user uses each payment instrument.

While user data, picker data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. In this example, the content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or a set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. Components of the order management module 220 include: an offering module 221, a servicing module 222, a communication module 223, a replacement module 224, and a compensation module 225, which are further described below.

The offering module 221 receives orders from user client devices 100 and offers the orders to pickers for service based on picker data. For example, the offering module 221 offers an order to a picker based on the picker's location and the source location from which the ordered items are to be collected. The offering module 221 may also offer an order to a picker based on how many items are in the order, a vehicle operated by the picker, the delivery location, the picker's preferences for how far to travel to deliver an order, the picker's ratings by users, or how often the picker agrees to service an order.

In some embodiments, the offering module 221 determines when to offer an order to a picker based on a delivery timeframe requested by the user who placed the order. The offering module 221 computes an estimated amount of time that it would take for a picker to collect the items for an order and deliver the ordered items to the delivery location for the order. The offering module 221 offers the order to a picker at a time such that, if the picker immediately accepts and services the order, the picker is likely to deliver the order at a time within the requested timeframe. Thus, when the offering module 221 receives an order, the offering module 221 may delay offering the order to a picker if the requested timeframe is far enough in the future (i.e., the picker may be offered the order at a later time and is still predicted to meet the requested timeframe).

When the offering module 221 offers an order to a picker, the servicing module 222 transmits the order to the picker client device 110 associated with the picker. The servicing module 222 may also transmit navigation instructions from the picker's current location to the source location associated with the order. If the order includes items to collect from multiple source locations, the servicing module 222 identifies the source locations to the picker and may also specify a sequence in which the picker should visit the source locations.

The servicing module 222 may track the location of the picker through the picker client device 110 to determine when the picker arrives at the source location. When the picker arrives at the source location, the servicing module 222 transmits the order to the picker client device 110 for display to the picker. As the picker uses the picker client device 110 to collect items at the source location, the servicing module 222 receives item identifiers for items that the picker has collected for the order. In some embodiments, the servicing module 222 receives images of items from the picker client device 110 and applies computer vision techniques to the images to identify the items depicted by the images. The servicing module 222 may track the progress of the picker as the picker collects items for an order and may transmit progress updates to the user client device 100 that describe which items have been collected for the user's order.

While a picker is servicing an order, the servicing module 222 may receive a notification from a picker client device 110 that an item included in an order is not available at a source location or it may determine whether an item collected by the picker is consistent with a set of constraints associated with a user who placed the order. For example, if a user specifies a budget for an order or an item included in the order, the servicing module 222 may determine that a replacement for an item collected by a picker servicing the order exceeds the budget. As an additional example, if a picker is servicing an order placed by a user who has unused credits provided by a food assistance program, the servicing module 222 may determine that a replacement for an item collected by the picker is not eligible to be acquired using the unused credits or may only be acquired using a number of credits that exceeds the number of unused credits. As yet another example, if a set of dietary restrictions associated with a user indicates that the user is allergic to eggs, the servicing module 222 may determine that a replacement for an item collected by a picker servicing an order placed by the user includes eggs.

In some embodiments, the servicing module 222 tracks the location of the picker within the source location. The servicing module 222 uses sensor data from the picker client device 110 or from sensors in the source location to determine the location of the picker in the source location. The servicing module 222 may transmit, to the picker client device 110, instructions to display a map of the source location indicating where in the source location the picker is located. Additionally, the servicing module 222 may instruct the picker client device 110 to display the locations of items for the picker to collect, and may further display navigation instructions indicating how the picker may travel from their current location to the location of the next item to collect for an order.

The servicing module 222 determines when the picker has collected the items for an order. For example, the servicing module 222 may receive a message from the picker client device 110 indicating that all of the items for an order have been collected. Alternatively, the servicing module 222 may receive item identifiers for items collected by the picker and determine when all of the items in an order have been collected. When the servicing module 222 determines that the picker has completed an order, the servicing module 222 transmits the delivery location for the order to the picker client device 110. The servicing module 222 may also transmit navigation instructions to the picker client device 110 that specify how to travel from the source location to the delivery location, or to a subsequent source location for further item collection. The servicing module 222 tracks the location of the picker as the picker travels to the delivery location for an order, and updates the user with the location of the picker so that the user can track the progress of the order. In some embodiments, the servicing module 222 computes an estimated time of arrival of the picker at the delivery location and provides the estimated time of arrival to the user.

In some embodiments, the communication module 223 facilitates communication between the user client device 100 and the picker client device 110. As noted above, a user may use a user client device 100 to send a message to the picker client device 110. The communication module 223 receives the message from the user client device 100 and transmits the message to the picker client device 110 for presentation to the picker. The picker may use the picker client device 110 to send a message to the user client device 100 in a similar manner. Messages sent between a user and a picker may be presented in a messaging interface associated with the user and the picker. Messages generated by the communication module 223 also may be presented in the messaging interface, as described below, or sent as push notifications, or via any other suitable means.

The communication module 223 may generate a message including a suggestion to replace an item that is not available at a source location with a replacement included among a set of replacements for the item and information describing the set of replacements. The message also may include an explanation describing a suitability of the set of replacements for the item. The message further may include additional types of content, such as interactive elements that allow a user to select a replacement for the item or to remove the item from an order, or any other suitable types of content. Once the communication module 223 generates the message, it may send the message to a user client device 100 associated with the user who placed the order, causing the message to be displayed (e.g., in the messaging interface associated with the user and a picker servicing the order, as a push notification, etc.). Alternatively, the communication module 223 may send the message to a picker client device 110 associated with the picker and the picker may communicate information describing the set of replacements for the item to the user (e.g., in a message presented in the messaging interface).

Upon receiving a selection of a replacement for an item from a user client device 100, the communication module 223 also may generate a message including a description of the selected replacement, which it may send to a picker client device 110, causing the message to be displayed (e.g., in the messaging interface, as a push notification, etc.). For example, the communication module 223 may generate a message indicating a user accepted a replacement for an item and information describing the replacement, and send the message to a picker client device 110 associated with a picker servicing an order that includes the item. In some embodiments, prior to generating and sending this message, the communication module 223 generates and sends one or more additional messages to the user client device 100 asking the user to confirm their selection. The additional messages may include an updated total associated with an order based on the selected replacement, an interactive element (e.g., a button) asking the user to confirm the selected replacement, etc. Upon receiving confirmation of the selected replacement from the user client device 100, the communication module 223 may send a message including the description of the selected replacement to the picker client device 110.

In some embodiments, the communication module 223 does not receive a selection of a replacement for an item from a user client device 100 within a threshold amount of time or confirmation of a selected replacement from the user client device 100 within a threshold amount of time. In embodiments in which the communication module 223 does not receive a selection of a replacement from the user client device 100 within a threshold amount of time, the communication module 223 may generate a message including a description of a set of replacements, which it may send to the picker client device 110, causing the message to be displayed (e.g., in the messaging interface). For example, the communication module 223 may generate and send a message to a picker client device 110 that states: “No response was received from the user. You may proceed with this item: 8 oz. Brand A butter.” In embodiments in which the communication module 223 does not receive confirmation of a selected replacement from the user client device 100 within a threshold amount of time, the communication module 223 may generate a message including a description of the selected replacement, which it may send to the picker client device 110, causing the message to be displayed (e.g., in the messaging interface).

The replacement module 224 may retrieve a set of user data for a user that it may use to identify a set of candidate replacement items or a set of replacement items, as further described below. The set of user data may include a set of constraints associated with the user. As described above, the set of constraints may include a budget associated with the user, a set of payment restrictions associated with the user, a set of dietary restrictions associated with the user, or any other suitable types of constraints. The set of user data also may include a set of preferences associated with the user, demographic or household information associated with the user, or any other suitable types of user data for the user.

The replacement module 224 may identify a set of candidate replacement items for a “target item,” which is an item included in an order that is not available at a source location. The replacement module 224 may do so when the servicing module 222 receives a notification from a picker client device 110 that the target item is not available or when the servicing module 222 determines that a replacement for the target item collected by a picker is inconsistent with a set of constraints associated with a user who ordered the target item. The replacement module 224 may identify the set of candidate replacement items for the target item by predicting a replacement score for each of multiple items available at the source location. The replacement score may correspond to a value (e.g., from zero to one) that indicates a measure of acceptability of an item as a replacement for the target item. The replacement module 224 may predict the replacement score for an item based on item data for the item and the target item. For example, a replacement score for an item may be proportional to a measure of similarity of attributes (e.g., a size, an item category, ingredients, etc.) of the item and a target item. The replacement module 224 also may predict the replacement score based on a set of user data for the user (e.g., dietary preferences, favorite items, a budget or payment restriction, etc.) or any other suitable types of information. In the above example, the replacement score also may be proportional to a measure of consistency of the attributes of the item with a set of dietary restrictions and a budget associated with a user. The replacement module 224 may then identify the set of candidate replacement items for the target item based on the replacement score for each item. For example, the replacement module 224 may identify a set of candidate replacement items from multiple items available at a source location, in which each candidate replacement item has at least a threshold replacement score (e.g., by ranking the items based on their replacement scores and identifying the set of candidate replacement items associated with at least a threshold ranking).

In some embodiments, the replacement module 224 predicts a replacement score for an item using a replacement prediction model, which is a machine-learning model trained to predict a replacement score for an item. To use the replacement prediction model, the replacement module 224 may access the model (e.g., from the data store 240) and apply the model to a set of inputs. The set of inputs may include various types of data described above (e.g., item data for an item available at a source location and a target item, a set of user data for a user, etc.). Once the replacement module 224 applies the replacement prediction model to the set of inputs, the replacement module 224 may receive an output from the model, which may include a value corresponding to a replacement score indicating whether an item is an acceptable replacement for a target item. In some embodiments, the replacement prediction model is trained by the machine-learning training module 230, as described below.

The replacement module 224 also may identify a set of replacements for a target item. The replacement module 224 may do so when the servicing module 222 receives a notification from a picker client device 110 that the target item is not available or when the servicing module 222 determines that a replacement for the target item collected by a picker is inconsistent with a set of constraints associated with a user who ordered the target item. The replacement module 224 may identify the set of replacements for the target item using a large language model (LLM) or any other suitable type of generative artificial intelligence (AI) model. The LLM may be tuned based on item data for items available at one or more source locations, budgeting information (e.g., how to identify replacements for the target item that are consistent with a budget), user data (e.g., user preferences, types of items that may be acquired by benefits provided by assistance programs associated with users of the online system 140, etc.), historical order data, or any other suitable types of information. In various embodiments, the LLM may access various types of information via one or more application programming interfaces (APIs). For example, via one or more APIs, the LLM may access item data for items available at a source location or search a catalog of items available at the source location to find replacements for a target item (e.g., by formulating a search query using parameters such as an item category or a budget associated with the target item, dietary preferences associated with a user, etc.). The LLM may be fine-tuned via reinforcement learning from human feedback (RLHF) or using any other suitable technique or combination of techniques. For example, the LLM may be fined-tuned based on whether users accepted replacements identified by the LLM or based on messages presented in the messaging interface associated with users and pickers once the replacements were suggested to the users (e.g., messages indicating why replacements were or were not acceptable).

To use the LLM, the replacement module 224 generates a prompt that it provides to the LLM to obtain an output. The prompt may include a set of item data for a target item, a description of a set of constraints associated with a user for whom a set of replacements is being identified, and a set of contextual information associated with an order that includes the target item. The prompt also may include a request to identify the set of replacements for the target item based on information describing a set of candidate replacement items available at a source location, the set of item data for the target item, the set of constraints, and the set of contextual information associated with the order. In embodiments in which the prompt includes a constraint corresponding to a payment restriction associated with the user, such as a set of unused benefits provided to the user by a food assistance program, the request may indicate that replacements that may be acquired by the set of unused benefits should be prioritized over other replacements for the target item. Furthermore, in such embodiments, the request also may indicate that if replacements that may be acquired by the set of unused benefits cannot be found, less expensive replacements should be prioritized over more expensive replacements. The prompt also may include additional types of information, such as a set of item data for each candidate replacement item, an additional request to generate an explanation describing a suitability of the set of replacements for the target item based on the set of constraints, or any other suitable types of information.

The following illustrates an example of a prompt generated by the replacement module 224. Suppose that the replacement module 224 generates a prompt including item data (e.g., an item category, a brand, a price, etc.) for a target item and a description of a set of constraints (e.g., a budget, payment or dietary restrictions, etc.) associated with a user who placed an order including the target item. In this example, the prompt also may include contextual information associated with the order, such as a set of item data for each additional item included in the order, a set of instructions associated with the order, messages associated with the order included in a messaging interface associated with the user and a picker servicing the order, etc. Continuing with this example, the prompt also may include a request to identify a set of replacements for the target item based on the item data, the set of constraints, and the contextual information. In the above example, if the replacement module 224 identifies a set of candidate replacement items for the target item, the request also may include information describing the set of candidate replacement items and indicate that the set of replacements may be identified from the set of candidate replacement items or based on attributes (e.g., item categories, ingredients, versions/varieties, etc.) of the set of candidate replacement items. In this example, the prompt also may include an additional request to generate an explanation describing a suitability of the set of replacements for the target item based on the set of constraints.

Continuing with the above example, once the replacement module 224 generates the prompt, it provides the prompt to the LLM. In this example, the LLM may be tuned based on budgeting information and information describing food assistance programs associated with users of the online system 140. In the above example, the LLM also may be tuned based on a set of item data for each item available at one or more source locations. Alternatively, in the above example, if the LLM may access the item data or search a catalog of items available at a source location via one or more application programming interfaces (APIs), the LLM may formulate a search query using parameters based on the prompt (e.g., an item category, a price, etc. associated with the target item) and analyze a set of search results. In this example, the LLM may then filter out items or candidate replacement items that are inconsistent with the set of constraints or are otherwise unlikely to be acceptable replacements for the target item (e.g., items/candidate replacement items that are unlikely to be ordered with additional items included in the order, items/candidate replacement items that are inconsistent with instructions included in messages associated with the order, etc.). In the above example, once the LLM identifies a set of replacements for the target item, it generates an output including information describing the set of replacements.

Once the replacement module 224 provides a prompt to the LLM to obtain an output, it extracts, from the output, information describing a set of replacements for a target item. Continuing with the above example, the replacement module 224 may extract text from the output describing the set of replacements for the target item, such as a brand, an item category, a size, a price, etc. associated with each replacement. In the above example, if the prompt includes the additional request to generate the explanation describing the suitability of the set of replacements for the target item based on the set of constraints, the replacement module 224 also may extract the explanation describing the suitability of the set of replacements for the target item. In this example, the explanation may indicate that each replacement for the target item is consistent with the user's budget (e.g., for the order or for the target item) or payment or dietary restrictions associated with the user.

The compensation module 225 coordinates payment by the user for the order. The compensation module 225 uses payment information provided by the user (e.g., a credit card number, a bank account, an electronic card for using benefits provided by a program, etc.) to receive payment for the order. In some embodiments, the compensation module 225 stores the payment information for use in subsequent orders by the user. The compensation module 225 computes the total cost for the order and charges the user that cost. The compensation module 225 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

In embodiments in which the replacement module 224 accesses and applies the replacement prediction model to predict a replacement score for an item, the machine-learning training module 230 may train the replacement prediction model. The machine-learning training module 230 may train the replacement prediction model via supervised learning or using any other suitable technique or combination of techniques based on data stored in the data store 240 or any other suitable types of data. To illustrate an example of how the machine-learning training module 230 may train the replacement prediction model, suppose that the machine-learning training module 230 receives a set of training examples. In this example, the set of training examples may include a set of attributes of each item included among an inventory of a source location (e.g., an item category, ingredients/materials, a version/variety, a size, a brand, a price, etc. associated with each item). In the above example, for each pair of items included among the inventory, the set of training examples also may include a label which represents an expected output of the replacement prediction model. In this example, the label may indicate whether an item of the pair is an acceptable replacement for an additional item of the pair, which may be determined manually (e.g., based on feedback received from one or more users who received replacements for items that were not available at source locations). Alternatively, in the above example, the set of training examples also may include a set of attributes of each of multiple users of the online system 140 and the label may indicate whether an item of each pair of items is an acceptable replacement for a user who received the item as a replacement for an additional item of the pair. Continuing with this example, the machine-learning training module 230 may then update a set of parameters of the replacement prediction model based on the sets of attributes, as well as the labels by comparing its output from input data of each training example to the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 retrains the machine-learning model using the additional training data, using any of the methods described above. This deployment and retraining process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

### Identifying a Set of Constraint-Consistent Replacements for an Item Using a Large Language Model

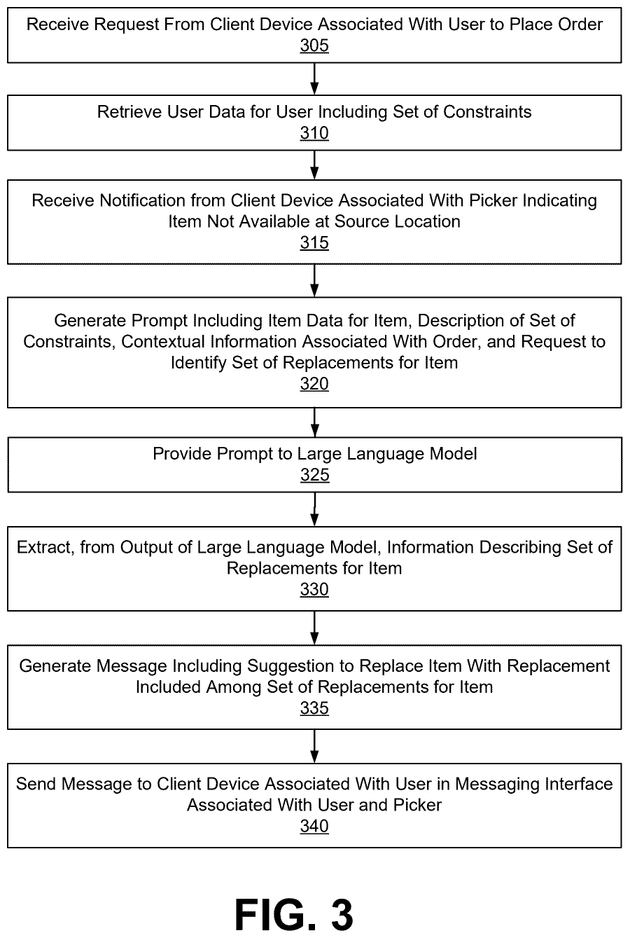

FIG. 3 is a flowchart for a method of identifying a set of constraint-consistent replacements for an item using a large language model, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 receives 305 (e.g., via the offering module 221) a request from a user client device 100 associated with a user of the online system 140 to place an order. The order may include one or more items and specify a source location from which the items is/are to be collected. The online system 140 then offers (e.g., using the offering module 221) the order to a picker who may then accept the order for servicing.

The online system 140 retrieves 310 (e.g., using the replacement module 224) a set of user data for the user. The set of user data may include a set of constraints associated with the user. The set of constraints may include a budget associated with the user, a set of payment restrictions associated with the user, a set of dietary restrictions associated with the user, or any other suitable types of constraints. The set of user data also may include a set of preferences associated with the user, demographic or household information associated with the user, or any other suitable types of user data for the user.

The online system 140 then receives 315 (e.g., via the servicing module 222) a notification from a picker client device 110 associated with the picker that an item (i.e., a target item) included in the order is not available at the source location. Alternatively, the online system 140 may determine (e.g., using the servicing module 222) that a replacement for the target item the picker has collected is inconsistent with the set of constraints associated with the user.

Responsive to receiving 315 the notification that the target item is not available or determining that a replacement collected by the picker is inconsistent with the set of constraints, the online system 140 may identify (e.g., using the replacement module 224) a set of candidate replacement items for the target item. The online system 140 may do so by predicting (e.g., using the replacement module 224) a replacement score for each of multiple items available at the source location. The replacement score may correspond to a value (e.g., from zero to one) that indicates a measure of acceptability of an item as a replacement for the target item. The online system 140 may predict the replacement score for an item based on item data for the item and the target item (e.g., such that the replacement score may be proportional to a measure of similarity of attributes of the item and the target item). The online system 140 also may predict the replacement score based on the set of user data for the user (e.g., such that the replacement score also may be proportional to a measure of consistency of the attributes of the item with a set of dietary restrictions, a set of preferences, a budget, etc. associated with the user). The online system 140 may then identify the set of candidate replacement items for the target item based on the replacement score for each item (e.g., by ranking the items based on their replacement scores and identifying the set of candidate replacement items associated with at least a threshold ranking).

In some embodiments, the online system 140 predicts a replacement score for an item using a replacement prediction model, which is a machine-learning model trained to predict a replacement score for an item. To use the replacement prediction model, the online system 140 may access (e.g., using the replacement module 224) the model (e.g., from the data store 240) and apply (e.g., using the replacement module 224) the model to a set of inputs. The set of inputs may include various types of data described above (e.g., item data for an item available at the source location and the target item, the set of user data for the user, etc.). Once the online system 140 applies the replacement prediction model to the set of inputs, it may receive (e.g., via the replacement module 224) an output from the model, which may include a value corresponding to a replacement score indicating whether an item is an acceptable replacement for the target item. In some embodiments, the replacement prediction model is trained by the online system 140 (e.g., using the machine-learning training module 230).

Responsive to receiving 315 the notification that the target item is not available at the source location or determining that a replacement collected by the picker is inconsistent with the set of constraints, the online system 140 also or alternatively may identify (e.g., using the replacement module 224) a set of replacements for the target item. The online system 140 may identify the set of replacements for the target item using a large language model (LLM) or any other suitable type of generative artificial intelligence (AI) model. The LLM may be tuned based on item data for items available at one or more source locations, budgeting information (e.g., how to identify replacements for the target item that are consistent with a budget), user data (e.g., user preferences, types of items that may be acquired by benefits provided by assistance programs associated with users of the online system 140, etc.), historical order data, or any other suitable types of information. In various embodiments, the LLM may access various types of information (e.g., item data) via one or more application programming interfaces (APIs). The LLM may be fine-tuned via reinforcement learning from human feedback (RLHF) or using any other suitable technique or combination of techniques.

To use the LLM, the online system 140 generates 320 (e.g., using the replacement module 224) a prompt that it provides 325 (e.g., using the replacement module 224) to the LLM to obtain an output. The prompt may include the set of item data for the target item, a description of the set of constraints associated with the user, and a set of contextual information associated with the order. The prompt also may include a request to identify the set of replacements for the target item based on information describing the set of candidate replacement items available at the source location, the set of item data for the target item, the set of constraints, and the set of contextual information associated with the order. In embodiments in which the prompt includes a constraint corresponding to a payment restriction associated with the user, such as a set of unused benefits provided to the user by a food assistance program, the request may indicate that replacements that may be acquired by the set of unused benefits should be prioritized over other replacements for the target item. Furthermore, in such embodiments, the request also may indicate that if replacements that may be acquired by the set of unused benefits cannot be found, less expensive replacements should be prioritized over more expensive replacements. The prompt also may include additional types of information, such as a set of item data for each candidate replacement item, an additional request to generate an explanation describing a suitability of the set of replacements for the target item based on the set of constraints, or any other suitable types of information. Once the online system 140 provides 325 the prompt to the LLM to obtain the output, it extracts 330 (e.g., using the replacement module 224), from the output, information describing the set of replacements for the target item.

The online system 140 may then generate 335 (e.g., using the communication module 223) a message including a suggestion to replace the target item with a replacement included among the set of replacements and information describing the set of replacements. The message also may include the explanation describing the suitability of the set of replacements for the target item. The message further may include additional types of content, such as interactive elements that allow the user to select a replacement or to remove the target item from the order, or any other suitable types of content.

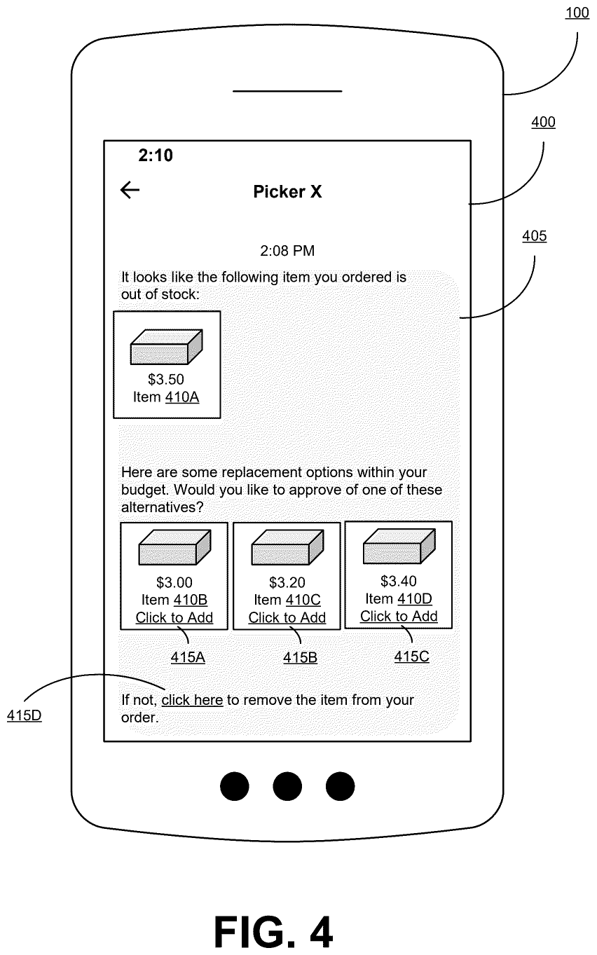

Once the online system 140 generates 335 the message, it may send 340 (e.g., using the communication module 223) the message to the user client device 100 associated with the user, causing the message to be displayed (e.g., in the messaging interface associated with the user and the picker, as a push notification, etc.). Alternatively, the online system 140 may send 340 the message to the picker client device 110 associated with the picker and the picker may communicate information describing the set of replacements for the item to the user (e.g., in a message presented in the messaging interface). FIG. 4 illustrates an example of a messaging interface 400 associated with a user and a picker, in accordance with one or more embodiments. As shown in the example of FIG. 4, the messaging interface 400 may include a message 405 indicating that the target item 410A is out of stock and that three replacements corresponding to items 410B-D are available. In this example, the message 405 also includes the price of each replacement and indicates that the replacements are being suggested because they are within the user's budget. In the above example, the message 405 also includes interactive elements 415A-C that allow the user to add a replacement as well as an interactive element 415D that allows the user to remove the target item 410A from the order.

In some embodiments, upon receiving (e.g., via the communication module 223) a selection of a replacement from the user client device 100, the online system 140 also generates (e.g., using the communication module 223) a message 405 including a description of the selected replacement, which it may send (e.g., using the communication module 223) to the picker client device 110, causing the message 405 to be displayed (e.g., in the messaging interface 400, as a push notification, etc.). In some embodiments, prior to generating and sending this message 405, the online system 140 generates (e.g., using the communication module 223) and sends (e.g., using the communication module 223) one or more additional messages 405 to the user client device 100 asking the user to confirm their selection. The additional messages 405 may include an updated total associated with the order based on the selected replacement, an interactive element (e.g., a button) asking the user to confirm the selected replacement, etc. Upon receiving (e.g., via the communication module 223) confirmation of the selected replacement from the user client device 100, the online system 140 may send a message 405 including the description of the selected replacement to the picker client device 110.

In some embodiments, the online system 140 does not receive a selection of a replacement from the user client device 100 within a threshold amount of time or confirmation of a selected replacement from the user client device 100 within a threshold amount of time. In embodiments in which the online system 140 does not receive a selection of a replacement from the user client device 100 within a threshold amount of time, the online system 140 may generate (e.g., using the communication module 223) a message 405 including a description of the set of replacements (e.g., “No response was received from the user. You may proceed with any of the following items: 8 oz. Brand A butter or 8 oz. Brand B butter.”). In such embodiments, the online system 140 may send (e.g., using the communication module 223) the message 405 to the picker client device 110, causing the message 405 to be displayed (e.g., in the messaging interface 400). In embodiments in which the online system 140 does not receive confirmation of a selected replacement from the user client device 100 within a threshold amount of time, the online system 140 may generate (e.g., using the communication module 223) a message 405 including a description of the selected replacement, which it may send (e.g., using the communication module 223) to the picker client device 110, causing the message 405 to be displayed (e.g., in the messaging interface 400).

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online system, a request from a first client device associated with a user of the online system to place an order comprising one or more items;
retrieving a set of user data for the user, wherein the set of user data comprises a set of constraints associated with the user and the set of constraints comprises a budget associated with the one or more items;
receiving, from a second client device associated with a picker servicing the order, a notification that an item of the one or more items is not available at a source location;
generating a prompt comprising:
a set of item data for the item,
a description of the set of constraints,
a set of contextual information associated with the order, and
a request to identify a set of replacements for the item based on information describing a set of candidate replacement items available at the source location, the set of item data for the item, the set of constraints, and the set of contextual information associated with the order;
providing the prompt to a large language model to obtain an output;
extracting, from the output, information describing the set of replacements for the item;
generating a message comprising a suggestion to replace the item with a replacement included among the set of replacements for the item; and
sending the message to the first client device associated with the user, wherein the sending causes the first client device to display the message in a messaging interface associated with the user and the picker.

2. The method of claim 1, wherein generating the prompt comprising the set of item data for the item, the description of the set of constraints, the set of contextual information associated with the order, and the request to identify the set of replacements for the item based on information describing the set of candidate replacement items available at the source location, the set of item data for the item, the set of constraints, and the set of contextual information associated with the order comprises:
including, in the prompt, an additional request to generate an explanation describing a suitability of the set of replacements for the item based at least in part on the set of constraints.

3. The method of claim 2, further comprising:
extracting, from the output, the explanation describing the suitability of the set of replacements for the item.

4. The method of claim 3, wherein generating the message comprising the suggestion to replace the item with the replacement included among the set of replacements for the item comprises:
including, in the message, the explanation describing the suitability of the set of replacements for the item.

5. The method of claim 1, wherein retrieving the set of user data for the user comprises:
retrieving the set of user data for the user, wherein the set of user data comprises the set of constraints associated with the user and the set of constraints further comprises one or more of: a set of dietary restrictions associated with the user or a set of payment restrictions associated with the user.

6. The method of claim 1, further comprising:
accessing a machine-learning model trained to predict a likelihood that a first item is an acceptable replacement for a second item, wherein the machine-learning model is trained by:
receiving item data for a first plurality of items included among an inventory of each source location of one or more source locations,
receiving, for each pair of items included among the inventory of each source location, a label indicating whether a first item of the pair of items is an acceptable replacement for a second item of the pair of items, and
updating a set of parameters of the machine-learning model based at least in part on the item data for the first plurality of items and the label for each pair of items;
for each item of a second plurality of items available at the source location, applying the machine-learning model to predict the likelihood that a corresponding item is an acceptable replacement for the item; and
identifying the set of candidate replacement items from the second plurality of items available at the source location based at least in part on the likelihood that each item of the second plurality of items is an acceptable replacement for the item.

7. The method of claim 1, further comprising:
fine-tuning the large language model via reinforcement learning from human feedback.

8. The method of claim 1, further comprising:
tuning the large language model based at least in part on one or more of: item data for a plurality of items available at the source location, budgeting information, or information describing benefits provided by other sources associated with one or more users of the online system.

9. The method of claim 1, wherein generating the prompt comprising the set of contextual information associated with the order comprises:
generating the prompt comprising one or more of: a set of item data for each item of the one or more items included in the order, a set of instructions associated with the order, or one or more messages associated with the order included in the messaging interface associated with the user and the picker.

10. The method of claim 1, further comprising:
receiving, from the first client device associated with the user, a selection of a replacement from the set of replacements for the item;
generating an additional message describing the selected replacement; and
sending the additional message to the second client device associated with the picker, wherein the sending causes the second client device to display the additional message in the messaging interface associated with the user and the picker.

11. A computer program product comprising a non-transitory computer-readable storage medium having instructions encoded thereon that, when executed by a processor, cause the processor to perform steps comprising:
receiving, at an online system, a request from a first client device associated with a user of the online system to place an order comprising one or more items;
retrieving a set of user data for the user, wherein the set of user data comprises a set of constraints associated with the user and the set of constraints comprises a budget associated with the one or more items;
receiving, from a second client device associated with a picker servicing the order, a notification that an item of the one or more items is not available at a source location;
generating a prompt comprising:
a set of item data for the item,
a description of the set of constraints,
a set of contextual information associated with the order, and
a request to identify a set of replacements for the item based on information describing a set of candidate replacement items available at the source location, the set of item data for the item, the set of constraints, and the set of contextual information associated with the order;
providing the prompt to a large language model to obtain an output;
extracting, from the output, information describing the set of replacements for the item;
generating a message comprising a suggestion to replace the item with a replacement included among the set of replacements for the item; and
sending the message to the first client device associated with the user, wherein the sending causes the first client device to display the message in a messaging interface associated with the user and the picker.

12. The computer program product of claim 11, wherein generating the prompt comprising the set of item data for the item, the description of the set of constraints, the set of contextual information associated with the order, and the request to identify the set of replacements for the item based on information describing the set of candidate replacement items available at the source location, the set of item data for the item, the set of constraints, and the set of contextual information associated with the order comprises:
including, in the prompt, an additional request to generate an explanation describing a suitability of the set of replacements for the item based at least in part on the set of constraints.

13. The computer program product of claim 12, wherein the computer-readable storage medium further has instructions encoded thereon that, when executed by the processor, cause the processor to perform steps comprising:
extracting, from the output, the explanation describing the suitability of the set of replacements for the item.

14. The computer program product of claim 13, wherein generating the message comprising the suggestion to replace the item with the replacement included among the set of replacements for the item comprises:
including, in the message, the explanation describing the suitability of the set of replacements for the item.

15. The computer program product of claim 11, wherein retrieving the set of user data for the user comprises:
retrieving the set of user data for the user, wherein the set of user data comprises the set of constraints associated with the user and the set of constraints further comprises one or more of: a set of dietary restrictions associated with the user or a set of payment restrictions associated with the user.

16. The computer program product of claim 11, wherein the computer-readable storage medium further has instructions encoded thereon that, when executed by the processor, cause the processor to perform steps comprising:
accessing a machine-learning model trained to predict a likelihood that a first item is an acceptable replacement for a second item, wherein the machine-learning model is trained by:
receiving item data for a first plurality of items included among an inventory of each source location of one or more source locations,
receiving, for each pair of items included among the inventory of each source location, a label indicating whether a first item of the pair of items is an acceptable replacement for a second item of the pair of items, and
updating a set of parameters of the machine-learning model based at least in part on the item data for the first plurality of items and the label for each pair of items;
for each item of a second plurality of items available at the source location, applying the machine-learning model to predict the likelihood that a corresponding item is an acceptable replacement for the item; and
identifying the set of candidate replacement items from the second plurality of items available at the source location based at least in part on the likelihood that each item of the second plurality of items is an acceptable replacement for the item.

17. The computer program product of claim 11, wherein the computer-readable storage medium further has instructions encoded thereon that, when executed by the processor, cause the processor to perform steps comprising:
fine-tuning the large language model via reinforcement learning from human feedback.

18. The computer program product of claim 11, wherein the computer-readable storage medium further has instructions encoded thereon that, when executed by the processor, cause the processor to perform steps comprising:
tuning the large language model based at least in part on one or more of: item data for a plurality of items available at the source location, budgeting information, or information describing benefits provided by other sources associated with one or more users of the online system.

19. The computer program product of claim 11, wherein generating the prompt comprising the set of contextual information associated with the order comprises:
generating the prompt comprising one or more of: a set of item data for each item of the one or more items included in the order, a set of instructions associated with the order, or one or more messages associated with the order included in the messaging interface associated with the user and the picker.

20. A computer system comprising:
a processor; and
a non-transitory computer-readable storage medium storing instructions that, when executed by the processor, perform actions comprising:
receiving, at an online system, a request from a first client device associated with a user of the online system to place an order comprising one or more items;
retrieving a set of user data for the user, wherein the set of user data comprises a set of constraints associated with the user and the set of constraints comprises a budget associated with the one or more items;
receiving, from a second client device associated with a picker servicing the order, a notification that an item of the one or more items is not available at a source location;
generating a prompt comprising:
a set of item data for the item,
a description of the set of constraints,
a set of contextual information associated with the order, and
a request to identify a set of replacements for the item based on information describing a set of candidate replacement items available at the source location, the set of item data for the item, the set of constraints, and the set of contextual information associated with the order;
providing the prompt to a large language model to obtain an output;
extracting, from the output, information describing the set of replacements for the item;
generating a message comprising a suggestion to replace the item with a replacement included among the set of replacements for the item; and
sending the message to the first client device associated with the user, wherein the sending causes the first client device to display the message in a messaging interface associated with the user and the picker.
